(19) United States
(12) Patent Application Publication
(10) Pub. No.: US 2014/0199450 A1
(43) Pub. Date: Jul. 17, 2014

(54) FRUIT SHELF-LIFE EXTENSION

(71) Applicant: 1,4 GROUP, INC., Meridian, ID (US)

(72) Inventors: JAMES ZALEWSKI, BOISE, ID (US); ADDIE WAXMAN, MERIDIAN, ID (US)

(73) Assignee: 1,4 GROUP, INC., MERIDIAN, ID (US)

(21) Appl. No.: 13/743,288

(22) Filed: Jan. 16, 2013

(51) Int. Cl. A23B 7/144

(52) U.S. Cl. CPC A23B 7/144
USPC 426/312; 426/321

(57) ABSTRACT

A method of maintaining freshly harvested fruit in a fresh condition includes treating freshly picked highly-hydrated fruit with a composition comprising a lower alkyl naphthalene at a rate of less than about 10 ppm. Another method includes treating freshly picked berries en route to market with a vapor of 1,4 DMN.

### CROSS-REFERENCE TO RELATED APPLICATIONS

This application is related to U.S. application Ser. No. ______ (Attorney Docket No. 1957-8886US) and U.S. application Ser. No. ______ (Attorney Docket No. 1957-8885US), respectively entitled “APPARATUS AND PROCESS FOR LOW-TEMPERATURE INJECTION OF A LIQUID CROP PRESERVATIVE FORMULATION” and “INJECTABLE LOW-TEMPERATURE CROP PRESERVATIVE FORMULATION,” having common inventorship and commonly assigned. The content of each is herein fully incorporated by reference.

### BACKGROUND OF INVENTION

Fruits such as raspberries, blackberries, strawberries and the like are fragile crops when intended to be fresh-market produce. Great care is taken in the field to avoid pests, minimize dehydration and the like. Such crops are generally handpicked and hand-placed in small shipping containers, frequently small, pint-sized or smaller ones made of plastic with aeration holes. Berries, which are damaged, are used for drinks, jellies and the like.

Even with such extraordinary care, any delays in transit between field and market often results in dehydration, shrinkage and mold or fungal growth, rendering such produce unfit for placement on a grocer's shelf. Also, even if such produce is hydrated and acceptably healthy appearing on a grocer's shelf, such produce frequently dehydrates and decays after purchase by a consumer, often resulting in a sizeable portion of the produce being unfit for consumption.

Because of the fragile nature of such produce and the fact that they must remain well hydrated and appear plump and healthy on a grocer's shelf, any mechanical handling, washing or the like has generally been avoided. Since these crops are not washed, application of various agricultural chemicals must be abated once the plant is beyond the blooming stage. Residues of chemicals deleterious to consumers on such produce could not be tolerated.

Berries, such as strawberries, blackberries, raspberries, blueberries and the like, are very susceptible to desiccation en route to market and on the shelf in grocery stores. Berries with a high moisture content are also subject to pressure bruising. Loss of moisture lends to shrinkage and large spoilage loss, which is a problem for berries for the fresh market.

Misters and the like are used in grocery stores in an attempt to maintain the moisture content of produce, such as lettuce and cabbage. However, drops of moisture on berries tend to promote mold, thus moisture is generally not used on berries in grocery stores. Fresh berries and the like are consumed fairly quickly after being picked. Thus, any agents applied to the berries may still be present in a minor quantity at the time of consumption by an ultimate consumer.

It has been reported that raspberries are particularly vulnerable to decay and that exposure to room temperature (68° F.) for 24 hours show substantial mold and decay. Blackberries are also very fragile. When picked, blackberries have the cap stay with the berry. In contrast, a raspberry cap stays with the stem, thereby exposing the interior of the berry, as well as its exterior, to dehydration and attack by pathogens. This hollow interior of the raspberry also causes it to have little resistance to being crushed.

U.S. Pat. No. 5,334,614 to Vaughn et al. suggests the use of 2-nonanone as a decay preventative for raspberries, blackberries, strawberries and the like. That patent describes the problems of picking, handling, cooling and shipment of these fragile fruits to market. While fungal growth is addressed, there is no suggestion that dehydration of the berries is decreased. The use of 2-nonanone as a potential agent for treating berries came from a recognition that it was one of an assortment of volatives emitted during ripening. No mention was made that alkyl naphthalenes were among the many volatile compounds given off by berries during ripening.

1,4 dimethylnaphthalene has been used to minimize sprouting of tubers, such as potatoes, and has been observed to reduce water loss of stored potatoes. Generally, 1,4 DMN is applied to stored potatoes to provide initial residues of at least about 2.0 ppm. It is known that 1,4 DMN is present naturally in potatoes initially after harvest and its diminishment has been associated with the end of dormancy, however, during dormancy the potatoes very slowly respire and dehydrate. Typically, 1,4 DMN is applied as an aerosol to stored potatoes, which are often stored for many months, frequently treated with the sprout inhibitor CIPC to prevent sprouting. Upon removal from storage, stored potatoes are washed to remove any residual chemicals.

### SUMMARY

One particular embodiment is drawn to a method of maintaining freshly harvested fruit in a fresh condition includes treating freshly picked highly-hydrated fruit with a composition comprising a lower alkyl naphthalene at a rate of less than about 10 ppm.

Another embodiment is drawn to a method that includes treating freshly picked berries en route to market with a vapor of 1,4 DMN.

### DETAILED DESCRIPTION

It has been discovered that treatment of freshly harvested, hydrated fruit (e.g., such as raspberries, blackberries, strawberries, blueberries and the like) with very low dosages of a lower alkyl naphthalene (e.g., 1,4 dimethylnaphthalene) in vapor form (e.g., in a gaseous state) maintains hydration and health of such treated berries for much longer periods after picking than berries that have not been treated. In particular embodiments, the success of such treatments with 1,4 dimethylnaphthalene (1,4 DMN) was greater at very lower dosages than at higher dosages.

In particular embodiments, treatment of the berries with a lower alkyl naphthalene may be accomplished by placing containers of berries having aeration holes in an enclosure, then introducing the chemical in vapor form. Alternatively, the chemical can be applied in aerosol form, which can quickly convert to a vapor, by virtue that the concentration of aerosol droplets is minor compared to the atmospheric volume of the enclosure. Other techniques of exposing the berries to a vapor of 1,4 DMN, for example, will be elucidated upon hereinafter.

In another embodiment, various dosages of 1,4 DMN, were introduced by placing berries in a one-half pint Mason jar, taping a cotton ball to the lid, placing a desired quantity of DMN on the cotton ball, then sealing the jar with the lid, and exposing the berries for brief periods to the vapor emanating from the cotton ball.

While the results of the experiment resulted in berries having improved hydration and shelf life for several dosage levels (e.g., dosages up to 50 ppm), the most significant improvement was observed at dosages below 10 ppm. Such improvement was noteworthy in comparison with a control group of berries to which no chemical was applied.

The control group, after about two days, began to show signs of dehydration, wrinkling, and unhealthy conditions such as mold. In contrast, those berries treated at a low dosage of 1,4 DMN appeared fresh, plump, more hydrated and had less mold or other unhealthy signs at the same elapsed time period. The berries treated at low dosage still looked fresh, hydrated and healthy about 7 days after treatment.

Although 1,4 DMN has a slight detectable odor, at a low dosage, the olfactory detection of 1,4 DMN was very minimal immediately after treatment and no odor was detected several days after treatment. Even immediately after treatment, no discernable flavor difference was detected.

### EXAMPLE I

Freshly harvested raspberries were treated with 1,4 DMN at various concentrations and an exposure time of about one hour.

Initial treatments were at an applied concentration (dosage) of 50 ppm, 10 ppm and 1.25 ppm with exposure of about one hour.

The improvement over untreated controls was minimally successful at levels of 50 ppm and 10 ppm with best results at 1.25 ppm.

The lowest dosage of 1,4 DMN yielded the following results:
1) Only a weight loss of 17% occurred at the harvest treatment level of 1,4 DMN versus 25% weight loss in the untreated berries.
2) Much better appearance at the lowest level of 1,4 DMN than at levels of 10 ppm, 50 ppm or untreated berries (control).
3) At the lowest level of 1,4 DMN, only 43% of the berries ultimately became moldy while 100% of the untreated berries (control) were moldy.

### EXAMPLE II

Fresh blackberries purchased at a grocery were treated in a manner similar to that set forth above with respect to raspberries. The blackberries treated with the lowest dosage of DMN maintained better hydration than the untreated control. Blackberries treated with all dosages of DMN stayed healthy in appearance and free of mold while 100% of untreated berries were contaminated with mold by day eight after treatment.

### EXAMPLE III

Freshly picked tomatoes were treated with DMN at dosages similar to those used with raspberries. The treated tomatoes maintained hydration. The untreated controls developed significant covering of mold, which was not observed in the treated tomatoes.

The action of 1,4 DMN with respect to mold resistance by the treated tomatoes may be attributed to PRP (pathogen resistant protein) response whereby certain proteins were expressed which trigger systemic resistance to mold development.

For more than a decade, 1,4 DMN (available as 1-4Sight® from 1,4 Group in Meridian, Id.) has been registered as a sprout inhibitor for potatoes and has been successfully used alone and in sequential applications with chloropropham (CIPC) to maintain potatoes in a non-sprouting condition for a whole storage season. Treatment of potatoes with 1,4 DMN has been performed during potato storage, during packaging, and during shipment.

Other chemicals used to treat potatoes (e.g., CIPC and/or essential oils, such as mint, clove) would not be acceptable for berry treatment. CIPC generally is not known to promote turgidity. Essential oils, also known as aromatic oils, each have a strong, distinct, persistent odor. Clove oil odor, for example, has been found objectionable to workers in potato packing sheds during post-storage treatment of potatoes with clove oil.

Blackberries and raspberries are particularly susceptible to compression damage. Blueberries and strawberries have better compression resistance and are often packaged in larger containers with the berries piled many rows deep. Blackberries and raspberries generally show more benefit from treatment with 1,4 DMN.

As indicated hereinabove, raspberries and blackberries are picked by hand and hand placed in small, aerated plastic containers with berries being only a few layers deep. Several techniques may be utilized to introduce a vapor of 1,4 DMN to such small containers. One technique is to place a small tag (e.g., a paper sticker) pretreated with 1,4 DMN in a predetermined amount, in each container, preferably on the inside lid of the container so that the picked berries are exposed to an atmosphere containing 1,4 DMN as soon as they are picked. The concentration of 1,4 DMN may be chosen to be sufficient to provide an effective dosage to maintain the berries in a highly hydrated state even after sitting on a grocer's shelf for many days, thus presenting a healthy, hydrated, plump appearance to customers.

The small plastic containers may also be treated when placed in larger boxes that, in turn, may be treated in a storage building with an appropriate concentration of 1,4 DMN-infused atmosphere produced by an aerosol or vapor of 1,4 DMN. Such a treatment may require several hours to complete to provide sufficient uptake of 1,4 DMN by the berries to maintain hydration through the transportation of the berries to an ultimate consumer.

Another technique for treating packaged berries with an appropriate dosage of chemical, e.g., 1,4 DMN, is to deposit droplets of said chemical on the inside of a shipping carton in which the small plastic containers are placed prior to shipment to market. This technique is illustrated and described in copending application U.S. application Ser. No. ______ (Attorney Docket No. 1957-8885US) and U.S. application Ser. No. ______ (Attorney Docket No. 1957-8886US) filed contemporaneously herewith and entitled INJECTABLE LOW-TEMPERATURE LIQUID CROP PRESERVATIVE FORMULATION and APPARATUS AND PROCESS FOR LOW-TEMPERATURE INJECTION OF A LIQUID CROP PRESERVATIVE FORMULATION, respectively, the full contents of each being incorporated herein by reference.

Another exemplary technique includes treating the berries in transit. Fresh berries may be transported for one or more days from a faun to a grocer's shelf. An atmosphere containing an appropriate concentration of 1,4 DMN can readily be created in a truck or a railroad car. One such product suitable for such purpose is 1,4 Ship, available from 1,4 Group, Meridian, ID. This is a device to inject a prescribed quantity of 1,4 DMN vapor into a large shipping container, such as a truck with an enclosed bed.

Vapor of 1,4 DMN may additionally contain vapor of 2-nonanone. Both of these chemicals are volatile and treatment of berries in vapor form of these is readily attainable. Other treatment methods such as aerosolization of a mixture of 1,4 DMN and 2-nonanone are also readily achievable. In a particular embodiment, an admixture of 1,4 DMN with any other chemical (e.g., 2-nonanone, solvents, diluents and the like) contains 1,4 DMN as the predominant chemical. Further, any chemical additive to 1,4 DMN should have sufficient volatility that such additive is substantially volatilized and has minimum to no presence on a berry at the time the berry is consumed, which is generally less than about one week after harvest.

What is claimed is:

1. A method of maintaining freshly harvested fruit in a fresh condition comprising: treating freshly picked highly-hydrated fruit with a composition comprising a lower alkyl naphthalene at a rate of less than about 10 ppm.

2. The method of claim 1, wherein said alkyl naphthalene is a dimethylnaphthalene.

3. The method of claim 2, wherein said dimethylnaphthalene is 1,4 dimethylnaphthalene.

4. The method of claim 3, wherein said dimethylnaphthalene is present on said berries at a dosage of less than about 1 ppm.

5. The method of claim 4, wherein said low dose is less than about 1.5 ppm.

6. The method of claim 1, wherein said alkyl naphthalene is contacted with said berries in an aerosol form.

7. The method of claim 1, wherein said alkyl naphthalene is contacted with said berries in vapor form.

8. The method of claim 1, wherein said berries are treated in bulk form.

9. The method of claim 1, wherein said berries are treated in packages.

10. The method of claim 1 wherein said fruit is berries.

11. A method of treating freshly picked berries en route to market comprises treating the berries with a vapor of 1,4 DMN.

12. The method of claim 10 wherein said vapor of 1,4 DMN additionally contains 2-nonanone vapor.
